(19) United States
(12) Patent Application Publication
(10) Pub. No.: US 2014/0314525 A1
(43) Pub. Date: Oct. 23, 2014

(54) RIVETING ELEMENT

(71) Applicant: Wistron Corporation, New Taipei City (TW)

(72) Inventors: Hao-Cheng KU, New Taipei City (TW); Yu-Ming LIN, New Taipei (TW)

(73) Assignee: Wistron Corporation, New Taipei City (TW)

(21) Appl. No.: 14/074,136

(22) Filed: Nov. 7, 2013

(30) Foreign Application Priority Data
Apr. 22, 2013 (TW) 102114263

(51) Int. Cl. F16B 19/06

(52) U.S. Cl. CPC F16B 19/06
USPC 411/501

(57) ABSTRACT

A riveting element is disclosed. The riveting element includes a main body, a riveting portion, and a riveting platform. The main body includes a second end. The riveting portion includes a clinch portion and a bottom plate, wherein the clinch portion and the bottom plate cooperatively define a groove. The riveting platform includes a first plane and second plane, wherein the first plane is connected with the second end of the main body and the second plane is connected with the clinch portion.

### FIELD

The exemplary embodiments of the present invention relate to a riveting element. More specifically, the exemplary embodiments of the present invention relate to a riveting element providing improved riveting quality.

### BACKGROUND

Please refer to FIGS. 1A and 1B, which are schematic diagrams of the riveting element in accordance with the prior arts related to the present invention. As shown in FIGS. 1A and 1B, the traditional riveting element 1 includes a main body 10, a clinch portion 20, a bottom plate 30, and a groove 40. In the traditional holeless riveting techniques, the punch 3 is used to apply strong pressure to the top of the riveting element 1, thus forcing the riveting element 1 into the corresponding connecting element 2 (such as a plate to be riveted). By the clinch portion 20 and the groove 40 disposed on the riveting element 1, the riveting element 1 can be combined closely with the corresponding connecting element 2.

However, it may be hard to control the force to be applied. If the applied force is insufficient, the pull-resistance/torque-resistance of the riveted riveting element 1 will be insufficient, and the riveting element 1 will fall off. In addition, there is no explicit stop structure to prevent the riveting element 1 from being over-pressured. Thus, when the applied force is too high, the thread of the riveting element 1 will be transformed, or the shape of the thread will be transformed or inclined. Since the combination of the riveting element 1 and the corresponding connecting element 2 is un-detachable, the riveting element 1 or the corresponding connecting element 2 cannot be repaired, and thus the whole product has to be abandoned only due to the bad quality of the combination. In addition, because the clinch portion 20 and the bottom plate 30 are pressed into the corresponding connecting element 2, their shape should be circular so as to make sure that the force is applied evenly. This limits the application of the riveting element 1 in that only isotropic pieces, such as a thread column, can be made.

Therefore, a new riveting element is needed to solve the disadvantages of the prior arts.

### SUMMARY

The main object of the present invention is to provide a riveting element that has an effect of raising the riveting quality between the riveting element and the corresponding connecting element.

In order to achieve the above object, according to one embodiment of the present invention, the riveting element is provided for being riveted to a corresponding connecting element. The riveting element comprises a main body, a riveting portion, and a riveting platform. The main body includes a second end. The riveting portion includes a clinch portion and a bottom plate, and the clinch portion and the bottom plate cooperatively define a groove. After being forced by a punch force, the riveting portion will be riveted to the corresponding connecting element. The riveting platform includes a first plane and second plane; the first plane is connected with the second end of the main body, and the second plane is connected with the clinch portion, wherein the distance between the edge of the first plane of the riveting platform and a central axis of the riveting element is larger than the distance between the edge of the main body and the central axis of the riveting element.

According to one embodiment of the present invention, the distance between the edge of the second plane of the riveting platform and the central axis of the riveting element is larger than the distance between the edge of the clinch portion and the central axis of the riveting element.

According to one embodiment of the present invention, the riveting platform has a geometric shape.

According to one embodiment of the present invention, the distance between the edge of the first plane of the riveting platform and the central axis of the riveting element is smaller than the distance between the edge of the second plane and the central axis of the riveting element, and therefore the periphery of the riveting platform is formed as an inclined plane.

According to one embodiment of the present invention, the main body has a columnar shape and a threaded hole is disposed thereon.

According to one embodiment of the present invention, the bottom plate has a circular shape.

According to one embodiment of the present invention, the edge of the bottom plate forms an inclined angle.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIGS. 1A and 1B are schematic diagrams of the riveting element in accordance with the prior arts related to the present invention.

FIGS. 2A and 2B are schematic diagrams of the riveting element in accordance with the first embodiment of the present invention.

FIGS. 3A and 3B are operation schematic diagrams of the riveting element in accordance with the first embodiment of the present invention.

FIG. 4 is a schematic diagram of the riveting element in accordance with the second embodiment of the present invention.

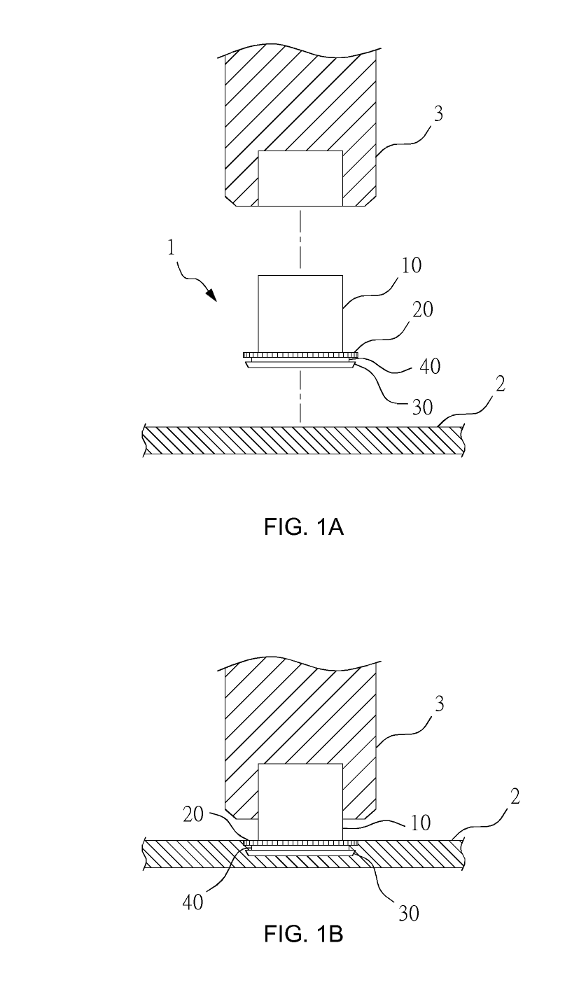

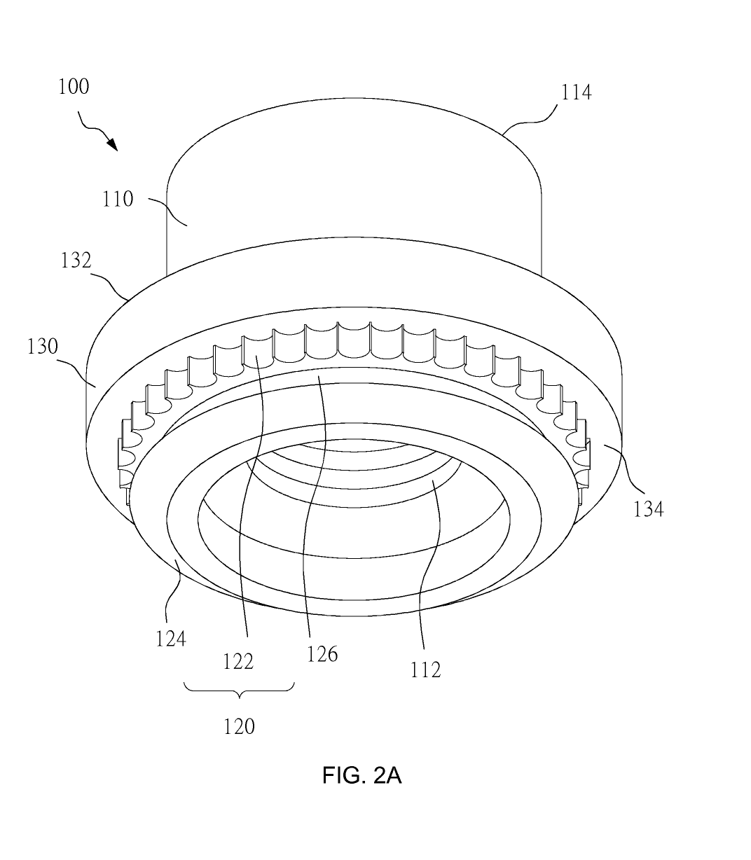

### DETAILED DESCRIPTION

For facilitating understanding and clarifying the object, characteristics, and advantages of the present invention, the following specific embodiments and figures of the present invention are presented as a detailed description.

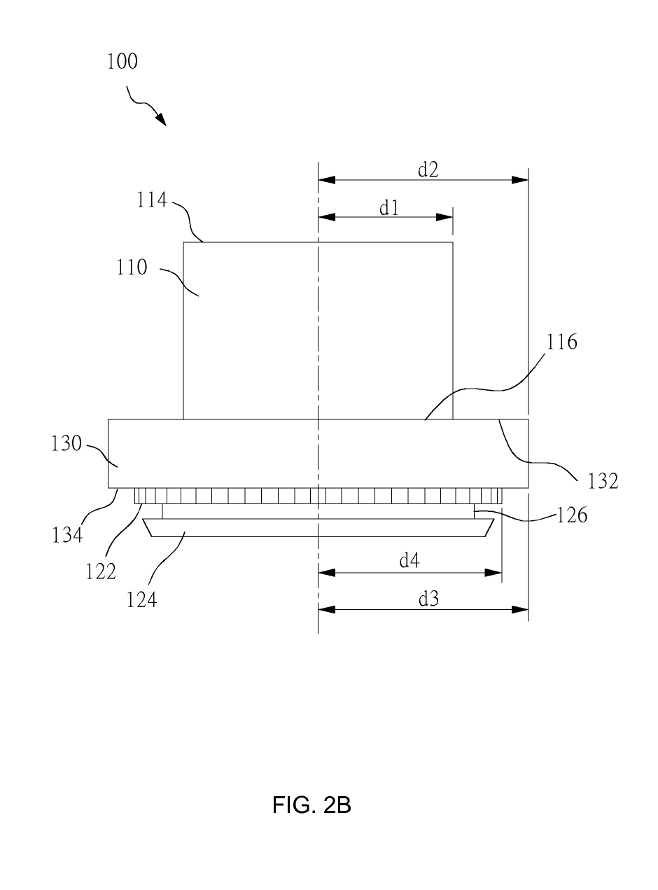

Please first refer to FIG. 2A and FIG. 2B, which are schematic diagrams of the riveting element in accordance with the first embodiment of the present invention. As shown in FIG. 2A and FIG. 2B, the riveting element 100 comprises a main body 110, a riveting portion 120, and a riveting platform 130, and the riveting element 100 is used for being riveted to a corresponding connecting element.

The main body 110 has a columnar shape and includes a first end 114 and a second end 116, and a threaded hole 112 is disposed inside the main body 110. The threaded hole 112 is a through hole and penetrates the main body 110, the riveting platform 130, and the riveting portion 120 from top to bottom. The threaded hole 112 is used for being screwed together with an external screw.

The riveting portion 120 includes a clinch portion 122 and a bottom plate 124. The clinch portion 122 and the bottom plate 124 cooperatively define a groove 126. The offcut of the corresponding connecting element generated during the riveting is partly accommodated in the groove 126. By the groove 126 engaging the corresponding connecting element, the stability of the riveting is ensured.

The bottom plate 124 has a circular shape, and the edge of the bottom plate 124 forms an inclined angle. During the process of riveting, in which the riveting element 100 enters the corresponding connecting element due to applied external force, the guiding of the inclined angle of the bottom plate 124 facilitates the passage of the riveting element 100 into the corresponding connecting element. Furthermore, due to the function of the clinch portion 122, the riveting element 100 cannot rotate any more after being riveted into the corresponding connecting element, and thus the torque-resistance after the riveting is increased.

The riveting platform 130 includes a first plane 132 and second plane 134, wherein the first plane 132 is connected with the second end 116 of the main body 110 and the second plane 134 is connected with the clinch portion 122. The distance d2 between the edge of the first plane 132 of the riveting platform 130 and a central axis of the riveting element 100 is larger than the distance dl between the edge of the main body 110 and the central axis of the riveting element 100; the distance d3 between the edge of the second plane 134 of the riveting platform 130 and the central axis of the riveting element 100 is larger than the distance d4 between the edge of the clinch portion 122 and the central axis of the riveting element 100. In addition, the bottom plate 130 has a circular shape, and the distances from the edges of the riveting platform 130 to the riveting element 100 are the same, but the present invention is not limited to this shape. For example, the plane shape of the riveting platform 130 can be a rectangle, a square, or another geometric shape, depending on the shape of the corresponding connecting element or the demands of fool-proofing, and therefore may be anisotropic.

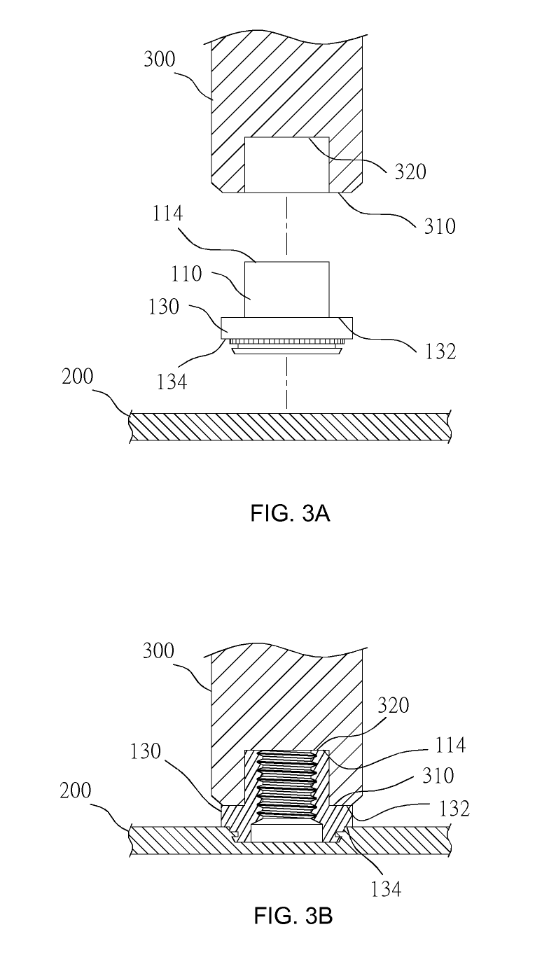

Next please refer to FIG. 3A and FIG. 3B, which are operation schematic diagrams of the riveting element in accordance with the first embodiment of the present invention. As shown in FIG. 3A and FIG. 3B, during the riveting process, the bottom plane 310 of the punch 300 will push the first plane 132 of the riveting platform 130 (the groove bottom plane 320 can also push the first end 114 of the main body 110), and the second plane 134 of the riveting platform 130 is used as a press-stopping position. When the second plane 134 of the riveting platform 130 is pushed closely against the corresponding connecting element 200, then the riveting element 100 is riveted to a predetermined position and over-pressing or under-pressing is avoided. In addition, the punch 300 applies force evenly on the first plane 132 of the riveting platform 130, so force is applied evenly to the riveting element 100 so as to avoid inclining of the riveting element 100 and further ensure that the pull-resistance can achieve the intended effect.

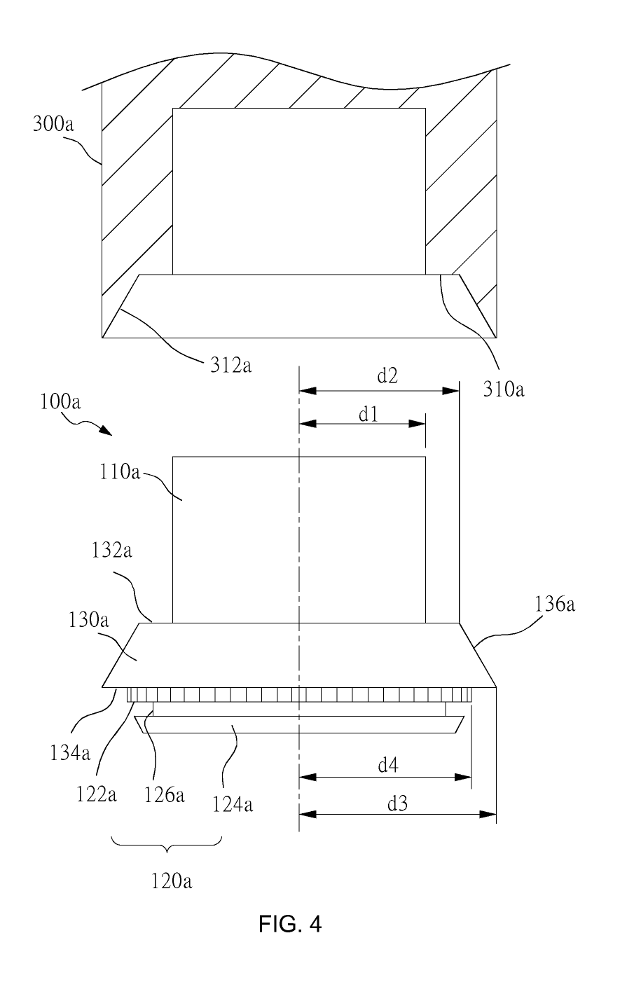

Next please refer to FIG. 4, which is a schematic diagram of the riveting element in accordance with the second embodiment of the present invention. As shown in FIG. 4, the riveting element 100a comprises a main body 110a, a riveting portion 120a, and a riveting platform 130a. The riveting portion 120a includes a clinch portion 122a and a bottom plate 124a. The clinch portion 122a and the bottom plate 124a cooperatively define a groove 126a. The riveting platform 130a includes a first plane 132a and second plane 134a. The first plane 132a is connected with the main body 110a, and the second plane 134a is connected with the clinch portion 122a.

The difference between the first and the second embodiments is that the distance d2 between the edge of the first plane 132a of the riveting platform 130a and the central axis of the riveting element 110a is smaller than the distance d3 between the edge of the second plane 134a and the central axis of the riveting element 100a; i.e., the periphery of the riveting platform 130a is formed as an inclined plane 136a so as to correspond to the inclined plane 312a formed on the bottom plane 310a of the punch 300a. Therefore, the riveting platform 130a can further provide an alignment function.

In summary, regardless of the function, the way and result of the present invention are shown to have technical characteristics different from those of the prior arts. However, the aforementioned embodiments are only for illustrating the principle and the result of the present invention and should not be construed to limit the range of the present invention. It will be obvious to those skilled in the art that, based upon the explanations herein, changes and modifications may be made without departing from the spirit of this invention and its broader aspects. Therefore, the appended claims are intended to encompass within their scope all such changes and modifications as are within the true spirit and scope of the exemplary embodiments of the present invention.

What is claimed is:

1. A riveting element, for being riveted to a corresponding connecting element, the riveting element comprising:
a main body, including a second end;
a riveting portion, including a clinch portion and a bottom plate, the clinch portion and the bottom plate cooperatively defining a groove; after being forced by a punch force, the riveting portion will be riveted on the corresponding connecting element; and
a riveting platform, including a first plane and second plane, the first plane being connected with the second end of the main body, the second plane being connected with the clinch portion, wherein the distance between the edge of the first plane of the riveting platform and a central axis of the riveting element is larger than the distance between the edge of the main body and the central axis of the riveting element.

2. The riveting element as claimed in claim 1, wherein the distance between the edge of the second plane of the riveting platform and the central axis of the riveting element is larger than the distance between the edge of the clinch portion and the central axis of the riveting element.

3. The riveting element as claimed in claim 1, wherein the riveting platform has a geometric shape.

4. The riveting element as claimed in claim 1, wherein the distance between the edge of the first plane of the riveting platform and the central axis of the riveting element is smaller than the distance between the edge of the second plane and the central axis of the riveting element, and therefore the periphery of the riveting platform is formed as an inclined plane.

5. The riveting element as claimed in claim 1, wherein the main body has a columnar shape and a threaded hole is disposed thereon.

6. The riveting element as claimed in claim 1, wherein the bottom plate has a circular shape.

7. The riveting element as claimed in claim 1, wherein the edge of the bottom plate forms an inclined angle.
